(19) United States
(12) Patent Application Publication
(10) Pub. No.: US 2007/0262718 A1
(43) Pub. Date: Nov. 15, 2007

(54) Electrode-foil interface structure

(76) Inventors: Deeder M. Aurongzeb, Mayfield Heights, OH (US); Rocco T. Giordano, Garfield Heights, OH (US); Karthik Sivaraman, Mayfield Heights, OH (US)

Correspondence Address: FAY SHARPE LLP, 1100 SUPERIOR AVENUE, SEVENTH FLOOR, CLEVELAND, OH, 44114, US

(21) Appl. No.: 11/433,235

(22) Filed: May 12, 2006

(51) Int. Cl. H01J 61/30; H01J 17/16

(52) U.S. Cl. 313/634

(57) ABSTRACT

A foil interface suited to interconnection of an electrode (18, 20) with an outer connector (24, 26) of a lamp includes a first electrically conductive connector (18, 20, 24, 26) includes a shank portion (46) and terminating in a shelf (48). A region (60) of progressively decreasing thickness is intermediate the shank portion and the shelf. An electrically conductive foil connector (28, 30) is mounted to the shelf adjacent a first end (70) of the foil connector.

### BACKGROUND OF THE INVENTION

The invention relates generally to electric lamps formed with a pinched seal or shrink seal, in which a molybdenum foil is incorporated in the pinch. In particular, it relates to an interface structure which decreases the risk of lamp failure in the region of the foil.

Electric lamps having a quartz glass lamp envelope frequently have outer current conductors of molybdenum which are connected to internal electrodes by a molybdenum foil. The foil is used in the area of the pinch seal. Being more flexible than the thicker molybdenum conductor, it is better able to absorb the stresses placed on the conductor in the seal area. However, there remains a tendency for failures to occur in the region of the seal. Such failures tend to occur where the voltage to the lamp is not properly regulated, leading to overheating in the foil area. For example, the seal can crack open, which results in lamp failure. Some of the failures are thought to be due to oxidation reaction of the molybdenum foil. During the sealing operation, microscopic passageways are formed around the lead wires as the vitreous material cools. These passageways permit oxygen or dose material to enter the foil area of the lamp seal and oxidize the foil, leading to overheating and cracking of the seal.

### BRIEF DESCRIPTION OF THE INVENTION

In accordance with one aspect of the exemplary embodiment, a foil interface is provided. The interface includes a first electrically conductive connector which includes a shank portion and terminates in a shelf. A tapered region is intermediate the shank portion and the shelf. An electrically conductive foil connector is mounted to the shelf adjacent a first end of the foil connector.

In another aspect, a lamp includes an envelope. At least one interior electrode is provided for generating light within the envelope during operation of the lamp. The interior electrode includes a shank portion and terminates in a shelf. A region of progressively decreasing thickness extends between the shank portion and the shelf. The lamp further includes an exterior connector and a foil connector which electrically connects the exterior connector with the interior electrode, the foil connector being mounted to the shelf.

In another aspect, a method of forming a foil interface includes providing a first electrically conductive connector comprising a shank portion and terminating in a shelf, a region of progressively decreasing thickness extending between the shank portion and the shelf. An electrically conductive foil connector is mounted to the shelf adjacent a first end of the foil connector.

In another aspect, a foil interface includes a first electrically conductive connector comprising a shank portion, the connector terminating in a shelf which is thinner than the shank portion. A region intermediate the shank portion and the shelf has a sloping surface which subtends an angle of less than 70° from a peripheral surface of the shank portion. An electrically conductive foil connector is mounted to the shelf.

### BRIEF DESCRIPTION OF THE DRAWINGS

FIG. 1 is a cross sectional view of a lamp according to the exemplary embodiment, with foils omitted for clarity, showing the envelope prior to pinching, the positions of the pinches being illustrated in phantom;

FIG. 2 is another cross sectional view of the lamp of FIG. 1, illustrating the foils and pinch or shrink seals;

FIG. 3 is an enlarged cross sectional view of the foil-electrode interface of the lamp of FIG. 1;

FIG. 4 is an enlarged cross sectional view of another embodiment of a foil-electrode interface for the lamp of FIG. 1; and

FIG. 4 is an enlarged bottom view of the foil and weld tab for the lamp of FIG. 1;

### DETAILED DESCRIPTION OF THE INVENTION

Aspects of the exemplary embodiment relate to systems and methods for reducing the failure of lamps due to lamp stem rupture. It is now proposed that one of the failure modes in the region of the pinch seal is due to stress risers. In a conventional molybdenum foil interface, the electrode and outer connector, which are electrically connected by the foil, are substantially thicker than the foil. It is proposed that the sharp corners created at the foil interface place stresses on the vitreous material in the region of the pinch seal and contribute to lamp failure. In the exemplary embodiment, a foil interface structure is designed to reduce these stress risers and thereby provide a lamp which is less prone to failure. As a result, the life of hermetic seals around the molybdenum foil and electric lamps employing such seals can be increased.

In various aspects, the interface is formed between an electrically conductive foil connector, such as a molybdenum-containing foil, and first and second electrically conductive connectors, such as an inner electrode and an outer connector of an electric lamp, respectively. The foil may be located in the pinch seal which is formed by pinching the vitreous material of a lamp envelope. The exemplary interface finds application in a variety of lamps, including discharge lamps and filament-containing lamps. It finds particular application in conditions where the voltage cannot be controlled well and, depending on the environment, the interface may reach temperatures in excess of 500° C.

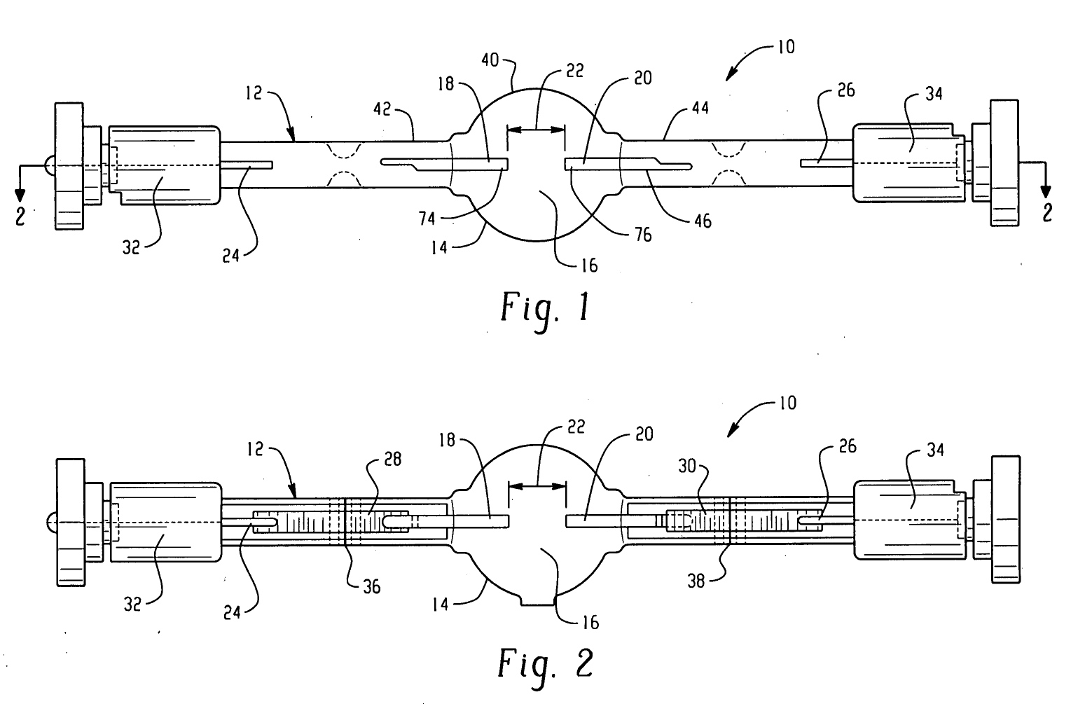

With reference to FIGS. 1 and 2, an exemplary lamp 10 includes a light source 12, such as a halogen tube. The tube 12 includes a light transmissive envelope 14, which is typically formed from a transparent vitreous material, such as quartz, fused silica, or aluminosilicate. The envelope defines an internal chamber 16. The envelope 14 may be coated with a UV or infrared reflective coating as appropriate. The exemplary lamp may be a high intensity discharge (HID) lamp which operates at a wattage of at least about 100 W, e.g., at least about 1000 W, and in one embodiment, up to about 4 kW, or higher. Accordingly, the lamp may run relatively hot. Lamps scaled to lower wattages can also run hot.

Hermetically sealed within the chamber 16 is a halogen fill, typically comprising an inert gas, such as xenon or krypton, and a halogen source, such as an alkyl halide, e.g., methyl bromide or other bromomethane. A pair of internal electrodes 18, 20 extend coaxial with the lamp axis into the chamber 16 from opposite ends thereof and define a gap 22 for supporting an electrical discharge during operation of the lamp. While the exemplary lamp is described in terms of tungsten electrodes 18, 20 as forming an energizable element for providing light, other energizable elements are contemplated, such as a filament.

The internal electrodes 18, 20, which serve as first connectors in the illustrated embodiment, may be formed primarily from an electrically conductive material, such as tungsten, e.g., at least 50% tungsten, and in one embodiment, at least about 80% or at least 99% tungsten. A longitudinal axis of internal electrodes 18, 20 is coincident with the longitudinal axis of the chamber 16. The internal electrodes 18, 20 are electrically connected with external connectors 24, 26 by foil connectors 28, 30 at an interface, as described in greater detail below. While in the illustrated embodiment, the electrode 18 is connected to the external connector 24 directly by the foil 28, it is also contemplated that one or more intermediate electrical connectors may space the foil connector 28 from the electrode 18, and similarly for electrode 20. Additionally, while connectors 24, 26 are shown extending from opposite ends of the lamp, it is also contemplated that they may extend in parallel from the same end of the lamp.

The illustrated external connectors 24, 26 extend outwardly to bases 32, 34 at respective ends of the envelope 14 for electrical connection with a source of power. Connectors 24, 26 may be in the shape of pins or tubes and may be formed primarily from an electrically conductive material, such as molybdenum or niobium, e.g., at least about 50% molybdenum, and in one embodiment, at least about 80% or at least 99% molybdenum. Other electrically conductive materials are also contemplated, such as a molybdenum alloy, e.g., a molybdenum nickel alloy.

During assembly of the lamp, the vitreous envelope material is pinched or shrunk, in the region of the foil connectors 28, 30, to form seals 36, 38 (illustrated in phantom in FIG. 1).

The illustrated lamp envelope 14 includes a bulbous central portion 40 and opposed stem portions 42, 44, which extend outwardly from the bulbous central portion along the longitudinal axis of the lamp 10. Other lamp configurations are also contemplated. For example, the lamp envelope 14 may have a substantially constant cross-sectional diameter. The foil connectors 28, 30 are situated in the thinned stem portions 42, 44. The foil connectors 28, 30 may be welded, brazed, or otherwise connected at ends thereof to the respective external connectors 24, 26 and internal electrodes 18, 20.

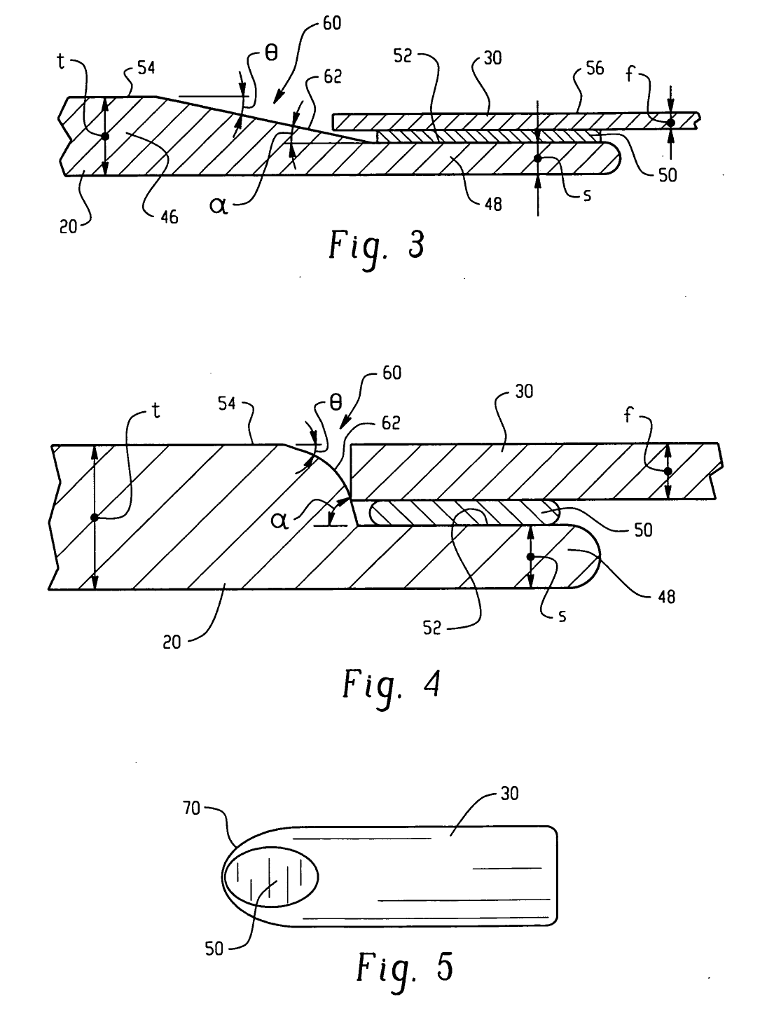

As illustrated in FIG. 3, an interface between the foil connector 30 and electrode 20 is shown by way of example. The interface between foil connector 28 and electrode 18 may be similarly configured. The foil connector 30 has a thickness, perpendicular to the longitudinal axis, which is substantially less than that of a shank portion 46 of the adjacent internal electrode 20. The electrode 20 terminates in a shelf 48. Specifically, a distal end of the shank portion 46 is cut away to define the shelf 48. The shelf 48 has a thickness s, in a direction perpendicular to the longitudinal axis of the lamp, which is less than a thickness t of the electrode shank portion 46 (for a cylindrical pin 20, t represents the maximum diameter). The illustrated foil connector 30 is mounted to the shelf 48. The foil connector 30 has a thickness f which may be less than the difference between t and s such that a weld tab 50 may be accommodated in the space between an upper, generally planar, surface 52 of the shelf and the periphery 54 of the shank portion 46 without a substantial mismatch between an upper (i.e., outer) surface 56 of the foil connector 30 and a shank peripheral surface 54. In the case of a cylindrical electrode 20, the peripheral surface 54 may be considered to be represented by a plane which lies tangential to the surface of the electrode 20 and parallel with the plane of the upper surface 56 of the foil connector 30. In the illustrated embodiment, the upper surface 56 is inset, relative to the shank surface 54, although it is also contemplated that the upper surface 56 may be coplanar with the peripheral surface 54 or slightly outward thereof. It will be appreciated that the terms “upper” and “lower” are used with respect to the orientation of the lamp shown in FIG. 3 and are not intended to limit the orientation of the lamp in use.

For example, the thickness of the foil connector may be less than about 0.5 mm, e.g., 0.2-0.3 mm and the width and length at least 1 mm respectively, generally at least 2 mm. For example, for a foil thickness f of about 0.25 mm, the shank may have a thickness t of about 1 mm, and the shelf may have a thickness s of about 0.3 to 0.5 mm. Where the foil connector is brazed rather than welded to the electrode 20, these dimensions may be adjusted somewhat to account for the absence of the tab 50. In this way, the foil does not protrude substantially beyond the peripheral surface 54 (in a direction perpendicular to a longest dimension of the first connector).

The shelf 48 is spaced from the peripheral surface 54 of the shank portion by a tapered region 60, i.e., a region of progressively diminishing thickness towards the shelf. In the illustrated embodiment, the region 60 has a generally planar sloping surface or riser 62 which interconnects the shelf 48 and peripheral surface 54. The surface 62 is angled to the peripheral surface 54 (and hence also to the longitudinal axis of the lamp, with which the electrode longest dimension is generally parallel) at less than 90°. This avoids the sharp corner which would occur where the surfaces 54, 62 meet if the riser were to be at 90° (i.e., perpendicular) to the peripheral surface 54. In particular, the surface 62 meets the peripheral surface 54 at an angle θ of less than 70°, e.g., less than 60°, or less than 50°, and in one embodiment, less than 45°, e.g., less than 30°. For example, the illustrated surface 62 slopes at an angle θ of about 20°, or less. In general, angle θ may be at least about 5°, and in one embodiment, at least 10°. The region 60 has an average thickness intermediate the shank portion and the shelf. In this embodiment, the average thickness is midway between the two, with the angle α between the surface 62 and shelf upper surface 52 being equal to θ, i.e., surface 62 has a substantially linear slope which may be formed, for example, by tapering the electrode at the desired angle.

The shelf 48 may be formed by cutting away the metal shank portion with a suitable cutting tool which is angled to the peripheral surface at a shallow angle, such as about 20°.

In other embodiments, the tapered region 60 may have a non linear slope. For example, as illustrated in FIG. 4, the region 60 is radiused at its intersection with the shank portion. In this embodiment, the angle α is closer to 90°. Such a contour may require use of a more precision cutting tool than for the embodiment of FIG. 3, or employ other forming techniques, such as molding.

With reference now to FIG. 5, to further reduce stress risers, the foil connector 30 may be curved, at an end 70 which is seated on the shelf, to further minimize sharp corners. In the illustrated embodiment, the end is radiused although other shapes, such as an elliptical or parabolic shaped end 70 are also contemplated. The weld tab 50 may be similarly profiled to fit within the radius of the end 70. In the illustrated embodiment, the tab 50 is elliptical. Alternatively, the tab 50 may be round. The diameter (or maximum diameter) of the tab 50 may be less than or equal to the width of the electrode shelf. Its thickness may be less than the thickness f of the molybdenum foil.

In one embodiment, the interface between the outer connector 26 and the foil 30 may be similarly configured to that shown in FIG. 3 or 4. Specifically, the outer connector 26 may have a shelf analogous to shelf 52 for receiving a second end of the foil connector 30 and a region of progressively diminishing thickness which can be a mirror image (optionally inverted) of the region 60. In yet another embodiment, only the outer connector is formed in this way.

The foil connectors 28, 30 each have a width and length which are substantially greater than a thickness of the foil connector.

When energized by the source of power, an electrical discharge 22 in the gap provides illumination as well as thermal energy. The thermal energy may be conducted by the electrodes 18, 20 and/or vitreous material to the pinch regions. The exemplary interface reduces the chance that the shape of the electrode will place an added stress on the pinch region, leading to lamp failure.

While the exemplary embodiment is described with respect to a tungsten-halogen lamp, it should be appreciated that other light sources may alternatively be employed, such as ceramic metal halide arc tubes, and the like. The term “energizable element,” as used herein, thus encompasses filaments and also other energizable materials which generate light on application of an electric current, such as the metal halide fill in the gap between the electrodes of a ceramic metal halide arc tube.

The foil connectors 28, 30 may be formed from a conductive foil material, such as molybdenum or an alloy thereof, such as a molybdenum-nickel alloy. The foil may comprise molybdenum as a primary component, e.g., at least 10% molybdenum and generally at least 40% or at least 50%. The foil may be substantially pure molybdenum, e.g., at least 95%, 99%, or 99.9% molybdenum. The foil 40 may be at least about 0.1 mm in thickness and may be up to about 0.5 mm, e.g., about 0.2 to about 0.3 mm. These dimensions may be scale up for higher wattages where similar structures can be used. The weld tab 50 may be formed of or plated with a material which is compatible with the electrode 20 and foil material and which melts at a lower temperature, such as platinum, e.g., at least 40%, 95%, 99%, or 99.9% platinum.

To form the electrode-foil interface, the tubular electrode 18, 20 may be cut with a saw or laser cutting tool to form the shelf. The foil may be etched, e.g., with an alkali such as NaOH, prior to welding. The foil connector 28 may be attached to the outer connector 24 and inner electrode 18 to form an electrical path therebetween, e.g., by welding with the platinum tab 50. For example, the shelf 48, foil 28, and tab 50 are heated together in an inert atmosphere, such as argon, to a sufficient temperature to melt the tab and form a permanent bond between the shelf 48 and the foil connector 28. Alternatively, the foil connector 28 may be attached by welding it directly to the electrode 18 and/or outer connector 24, without any intervening brazing material. The interface assembly 24, 28, 18, and corresponding interface assembly 20, 30, 26 may then be fitted into respective ends of the envelope 14 such that tips 74, 76 of electrodes 18, 20 protrude into the chamber 16 and are spaced by a suitable gap 22. The envelope 14 is heated and constricted adjacent the foil connectors 28, 30 to form the pinch seals 36, 38. Base connectors 32, 34 may then be connected with outer electrodes 24, 26. The finished lamp 10 may be positioned in a suitable housing comprising a reflector (not shown) and connected with a source of electrical power.

In addition to reducing lamp stem rupture by reducing stress risers, the exemplary interface may also reduce lamp stem rupture which may occur due to air trap formation and may also reduce materials waste.

The invention has been described with reference to the preferred embodiments. Obviously, modifications and alterations will occur to others upon reading and understanding the preceding detailed description. It is intended that the invention be construed as including all such modifications and alterations.

What is claimed is:

1. A foil interface comprising:
a first electrically conductive connector comprising a shank portion and terminating in a shelf, a tapered region intermediate the shank portion and the shelf; and
an electrically conductive foil connector mounted to the shelf adjacent a first end of the foil connector.

2. The foil interface of claim 1, further comprising a second electrically conductive connector, the foil connector mounted to the second electrically conductive connector adjacent a second end of the foil connector.

3. The foil interface of claim 1, wherein the foil connector comprises molybdenum.

4. The foil interface of claim 1, wherein the electrically conductive connector comprises tungsten.

5. The foil interface of claim 1, wherein the tapered region includes a sloping surface.

6. The foil interface of claim 1, wherein the sloping surface subtends an angle of less than 70° to a peripheral surface of the shank portion.

7. The foil interface of claim 6, wherein the sloping surface subtends an angle of less than 45° to the peripheral surface of the shank portion.

8. The foil interface of claim 7, wherein the sloping surface subtends an angle of about 20° to the peripheral surface of the shank portion.

9. The foil interface of claim 1, wherein the foil connector does not protrude, in a direction perpendicular to a longest dimension of the first connector, beyond a peripheral surface of the first connector.

10. The foil interface of claim 1, wherein the foil connector is less than about 0.4 mm in thickness.

11. The foil interface of claim 1, wherein the foil connector is welded to the shelf with a weld tab.

12. The foil interface of claim 1, wherein the first end of the foil connector is curved.

13. A lamp comprising the foil interface of claim 1.

14. The lamp of claim 13, further comprising an envelope formed of a vitreous material, the envelope being pinch sealed in a region of the foil connector.

15. The lamp of claim 13, wherein the first connector comprises an electrode which, in lamp operation, generates a discharge.

16. The lamp of claim 13, wherein the foil interface electrically connects an electrode with a source of power.

17. A lamp comprising:
an envelope;
at least one interior electrode for generating light within the envelope during operation of the lamp, the interior electrode comprising a shank portion and terminating in a shelf, a region of progressively decreasing thickness extending between the shank portion and the shelf;
an exterior connector; and
a foil connector which electrically connects the exterior connector with the interior electrode, the foil connector being mounted to the shelf.

18. A method comprising:
providing a first electrically conductive connector comprising a shank portion and terminating in a shelf, a tapered region extending between the shank portion and the shelf; and
mounting an electrically conductive foil connector to the shelf adjacent a first end of the foil connector to form a foil interface.

19. The method of claim 18, further comprising positioning the foil interface in a tubular stem formed from a vitreous material with a longest dimension of the first electrically conductive connector generally parallel with a longitudinal axis of the tube and pinching the tubular stem in the region of the foil connector to form a seal.

20. A method of forming a lamp comprising:
electrically interconnecting an interior electrode and exterior connector with the foil connector including forming a foil interface by the method of claim 19;
positioning the interior electrode within an envelope; and
sealing the envelope by pinching the envelope in a region of the foil connector.

21. A foil interface comprising:
a first electrically conductive connector comprising a shank portion, the connector terminating in a shelf which is thinner than the shank portion, a region intermediate the shank portion and the shelf having a sloping surface which subtends an angle of less than 70° from a peripheral surface of the shank portion; and
an electrically conductive foil connector mounted to the shelf.

22. A lamp comprising the foil interface of claim 21.
